(19) United States
(12) Patent Application Publication
(10) Pub. No.: US 2013/0183030 A1
(43) Pub. Date: Jul. 18, 2013

(54) SYSTEM FOR TESTING OF OPTICAL NETWORK

(71) Applicants: Jeroen Antonious Maria Duis, Didam (NL); Jan Willem Rietveld, Benschop (NL)

(72) Inventors: Jeroen Antonious Maria Duis, Didam (NL); Jan Willem Rietveld, Benschop (NL)

(73) Assignee: TYCO ELECTRONICS NEDERLAND BV, 's-Hertogenbosch (NL)

(21) Appl. No.: 13/349,119

(22) Filed: Jan. 12, 2012

(51) Int. Cl. H04B 10/08; H04B 17/00; B32B 38/10; G02B 6/36

(52) U.S. Cl. 398/25; 385/78; 156/154

(57) ABSTRACT

A network comprising: (a) a fiber having first and second ends; (b) a transmitter connected to the first end of the fiber and configured to launch a test signal having a first wavelength down the fiber; and (c) a thin-film selective reflector configured to reflect the first wavelength, the thin-film selective reflector optically connected to the second end of the first fiber.

### FIELD OF INVENTION

This invention relates generally to an approach for reflecting signals of a certain wavelength, and, more specifically, to a low cost thin-film selective reflector for facilitating testing of an optical network.

### BACKGROUND OF INVENTION

Fiber-to-the-home (FTTH) is a form of fiber optic communication delivery in which the fiber extends from the central office to the subscriber's premises. Referring to FIG. 7, a schematic of a fiber-to-the home network is shown. The network 700 comprises a central office 701, which is the physical building used to house inside plant equipment including various servers such as ISPs, IPTV, CATV and PSIN. A physical layer, comprising multiple fibers 704, connects the central office 701 to modems 703 at the user premises. In this particular illustration, each fiber 704 corresponds to a single dwelling unit 705a, a multi-dwelling unit 705b, or a building 705c. Such modems 703 are known, and serve to convert optical signals to electronic signals for use in cable television, internet PC and voice over internet among other applications. The modems 703 may be used in different configurations. For example, referring to FIG. 7, a single modem 703 corresponds to the single dwelling unit 705a, and multiple modems 703 correspond to multiple dwelling units 705b or a building 705c.

In the event a user loses a signal in the network 700, troubling shooting the problem requires isolating it to the physical layer or the active components, which are downstream of the modem 703. Isolating the problem to the physical layer is particularly important because the physical layer tends to be vast, extending for many miles—thus it is critical to narrow the geographical area in which the problem lies. Isolating the problem is also necessary to determine the type of response needed to resolve it. For example, a problem in the physical layer may require a crew in the field to repair the fiber 704, or a technician at the premises to the terminate the user's modem to a different fiber. On the other hand, a problem with the active components requires the technician to access the premises and troubleshoot the specific active components involved.

A preferable way of isolating a problem in an optical network is to provide a transmitter 702 that transmits a test signal having a certain wavelength that is different from the other signals being transmitted over the network. Specifically, the test signal is transmitted down the fiber 704 and is reflected back to the central office using wavelength selective filters 710. Because the wavelength selective filter 705 is located at each premises, it reflects a signal that is representative of the condition of the fiber leading to that premises. If the test signal is not received or is not received in the same condition in which it was transmitted, then the physical layer leading to that premises is compromised in some way. Because the test signal has a wavelength that is different from the other signal wavelengths, it does not interfere with the downstream conversion for use in CATV or PC or voiceover internet.

The currently preferred wavelength selective filter 710 is an add/drop filter. Such filters are well known. Briefly, they comprise essentially three components—a common fiber, a pass-through fiber and a reflective fiber. The fiber 704 is optically coupled to the common fiber and all signal wavelengths except for the test signal are allowed to pass through to the pass-through fiber. The selective wavelength is reflected back on the reflective fiber, which is also optically coupled to the fiber 704, such that the test signal is reflected back down fiber 704 and into the control office where a monitor (not shown) records the reflected test signal. If there is a disruption on the physical layer, the “fingerprint” of the test signal will change.

Although add/drop filters provide a reliable and efficient approach for reflecting a test signal back to the central office, these filters have a number of discrete components and tend to be costly and time consuming to install. Thus, there is a need for a less expensive, more readily installed solution. To this end, Applicants considered using a fiber grating at the modem 703. Such fiber gratings are low cost due to their high integration factor, especially in a patch cord configuration. Unfortunately, fiber gratings do not have the required bandwidth to reflect the test signal. For example, the test signal may have a wavelength of 1625 nanometers+/−20 nanometers. Fiber grating reflectors, however, tend to be capable of selectively reflecting only about 1 nanometer. Thus, the margin of error of the test signal is significantly greater than the reflective bandwidth of the fiber grating.

Therefore, a need exists for a selective reflector that is low cost, readily integrated with the network at the user's premises, and has sufficient bandwidth to reflect a test signal with normal wavelength variations. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides a low cost selective reflector filter for use in verification of the physical layer of an optical network. Specifically, the invention introduces a thin film selective reflector that is conveniently inserted into the optical path of the physical layer. Furthermore, by disposing the thin-film selective reflector on the end face of a ferrule, the thin-film selective reflector can be integrated into traditional optical components, such as, patch cords, splices, and connectors, which, in turn, are readily installed in the optical network.

Accordingly, one aspect of the present invention is an optical network having the thin-film selective reflector optically linked to the physical layer near the user's premises. In one embodiment, the network comprises: (a) a fiber having first and second ends; (b) a transmitter connected to the first end of the fiber and configured to launch a test signal having a first wavelength down the fiber; and (c) a thin-film selective reflector configured to reflect the first wavelength, the thin-film selective reflector optically connected to the second end of the first fiber.

Another aspect of the invention is a thin-film selective reflector incorporated into an optical ferrule. In one embodiment, the thin-film selective reflector comprises: (a) a ferrule having a mating face; (b) a fiber having a first end disposed in the ferrule and having an end face presented at the mating face; and (c) a thin layer of reflective material disposed on the mating face covering at least the end face. The ferrule may be incorporated into any components that traditionally use a ferrule, including, for example, connectors, patch cords and splices.

Yet another aspect of the invention is a method of preparing thin-film selective reflectors. In one embodiment, the method comprises: (a) terminating a fiber with at least one ferrule and polishing a mating face of the ferrule to present an end face of the fiber; and (b) disposing a thin film of reflective material on at least the end face of the fiber to reflect a certain wavelength.

### BRIEF DESCRIPTION OF FIGURES

FIG. 1 shows an optical network comprising one embodiment of the thin-film selective reflector of the present invention.

FIG. 2 shows a ferrule embodiment of the present invention having a thin-film selective reflector

FIG. 3 shows a patch cord embodiment of the present invention in which the ferrule of FIG. 2 is integrated with one of the connectors on the patch cord.

FIG. 4 shows a splice embodiment of the present invention in which the ferrule of FIG. 2 is integrated with one of the ferrule in the splice.

FIG. 5 shows a build-out connector embodiment of the present invention in which the ferrule of FIG. 2 is integrated into a built out connector for connection to another connector.

FIG. 6 shows a field installable connector embodiment of the present invention in which the ferrule of FIG. 2 is incorporated into a field-installable connector.

FIG. 7 shows a prior art optical network with test signal system to check connectivity of physical layer of network.

### DETAILED DESCRIPTION

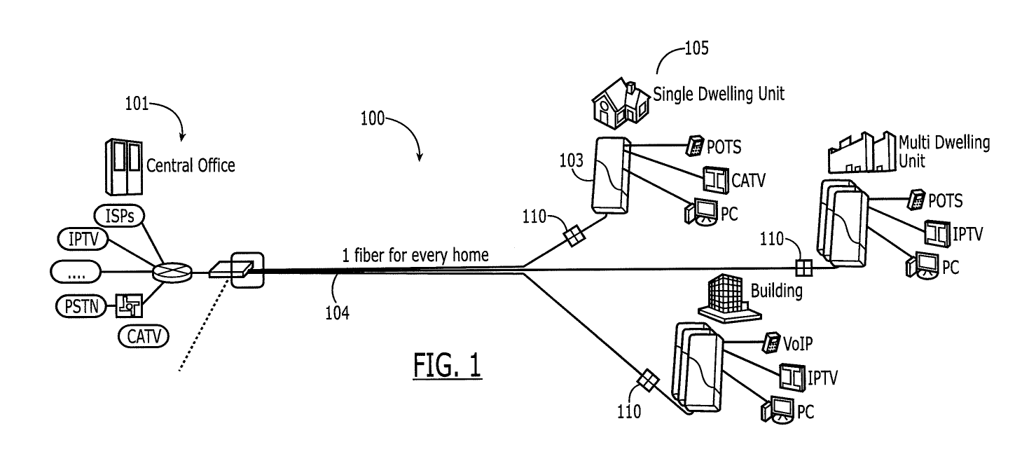

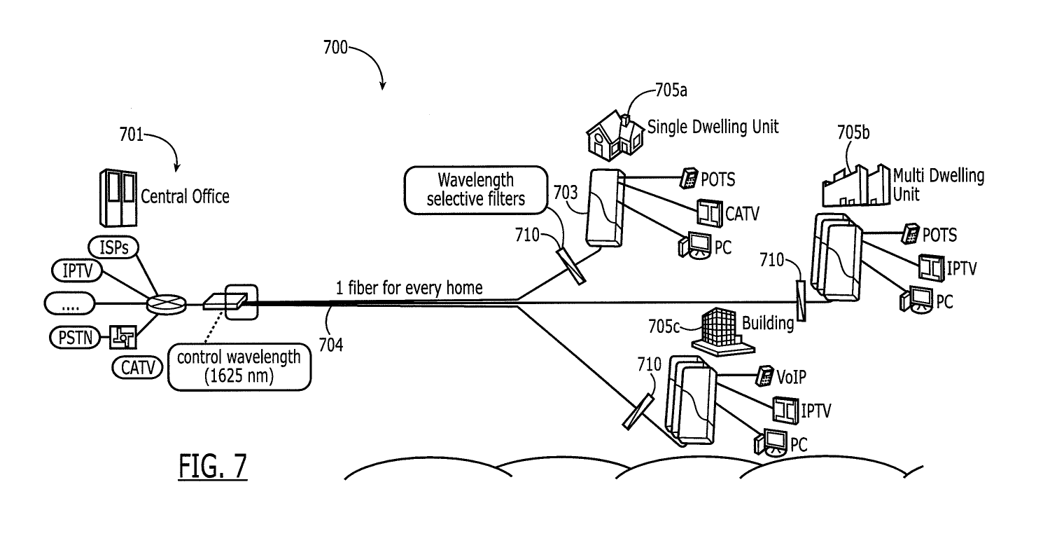

Referring to FIG. 1, one embodiment of the optical system 100 of the present invention is shown. In many respects, the optical system 100 is similar to the prior art optical network 700 of FIG. 7. For instance, the central office 101 transmits various optical signals for internet, television, video on demand, and other telecommunications down a physical layer comprising fibers 104. Each fiber enters a user's premises 105, and is operatively connected to a modem 103 at which point the optical signals are converted to electrical signals/wireless signals for internet, television, telephone, and whatever other applications are desired. In this embodiment, a discrete fiber 104 corresponds to a single premises 105.

The system 100 also comprises a transmitter 102 for transmitting a test signal having a first wavelength. However, unlike prior art systems having a discrete add/drop filter proximate to the modem 103, in this embodiment of the present invention, a thin-film selective reflector 110 is optically connected between the fiber 104 and the modem 103.

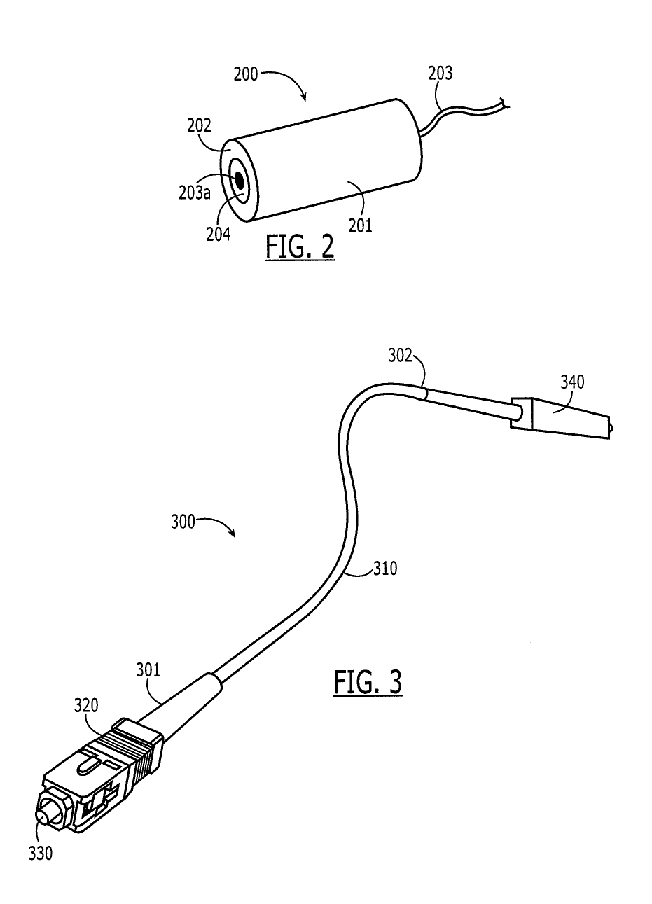

The thin film reflective filter is normal to the direction of light propagation and may have various embodiments. For example, referring to FIG. 2, a ferrule assembly 200 is shown comprising a ferrule 201 having a mating face 202 and containing a fiber 203 having an end face 203a presented at the mating face 202. A thin film 204 is disposed on the mating face 202 at least to the extent that it covers the end face 203a. The material and the thickness of the thin film filter are configured to reflect the wavelength of the test signal. The ferrule assembly 200 may be incorporated essentially into any optical component known to use a ferrule. Such optical components include, for example, optical connectors, splices, and active components (e.g., transceivers, receivers, and transmitters).

When the test signal is transmitted down the fiber 104 and encounters the thin-film selective reflector 110, it is reflected back through the fiber 104 to the transmitter 102 and a monitor at the central office. Depending on the quality of the test signal received by the monitor, the condition of the physical layer can be determined. Each of these components is described in greater detail below.

It should be understood that when reference is made to the thin-film selective reflector being between the fiber 104 and the modem 103, this does not necessarily mean it is directly connected between these components. For example, there may be intermediate fibers and components between the thin-film selective reflector and the fiber 104. Likewise, there may be intermediate fibers and components between the thin-film selective reflector and the modem 103. Such variations will be obvious to one of skill in the art in light of this disclosure.

The thin-film selective reflector 110 functions to dispose a thin-film selective reflector in the optical path between the fiber 104 and the modem such that it reflects the test signal back to a monitor. The thin-film selective reflector may be configured in different ways. For example, in FIG. 3, the thin-film selective reflector is embodied in a patch cord 300. Specifically, the patch cord comprises a fiber segment 310, in which a ferrule assembly 330 is terminated at its first end 301. The ferrule assembly 330 is similar to that ferrule assembly 200 described above. In this embodiment, the ferrule assembly 330 is contained in a first connector 320. The second end 302 of the fiber segment 310 is also terminated with a second connector 340. Unlike the first connector 320, however, the second connector comprises a traditional ferrule—i.e., it does not have a thin film selective reflector disposed on it. It should be obvious to one of skill that the patch cord embodiment of FIG. 3 can be used as any traditional patch cord application to jumper signals between different components such as routers and modems as is known in the art using conventional connectors.

The first and second connectors 320, 340 may be any known single or multi-fiber connector, including, for example, traditional SC, ST and FC-type connectors, small form factor designs, such as, MU and LC connectors, and multi-fiber connectors such as the MTRJ, MPX, and MPO-type connectors. Although a single fiber, SC-type connector is depicted in FIG. 3, it should be understood that the invention is not limited to single fiber ferrules/connectors and that the thin-film selective reflector of the present invention may be incorporated into multi-fiber ferrules/connectors. The first and second connectors 320, 340 are typically, although not necessarily, the same style connector.

Referring to FIG. 4, another embodiment of the thin-film selective reflector of the present invention is shown in which the thin-film selective reflector is a splice 400. Like the patch cord embodiment of FIG. 3, the splice 300 comprises the fiber segment 410 terminated at one end with a ferrule assembly 430 having a thin-film selective reflector as described with respect to the ferrule assembly 200. However, rather than terminating the second end of the fiber segment 410 with a second connector as in the patch cord embodiment of FIG. 3, the splice 400 optically couples the ferrule assembly 430 to a second ferrule assembly 440 terminated at an end of a second fiber segment 411. The second ferrule is a conventional ferrule, meaning it does not have a thin-film selective reflector. The ferrules are optically coupled using a coupling mechanism 450. Such coupling mechanisms are well known and include, for example, alignment sleeves. An alignment sleeve is a closely toleranced tube into which cylindrical ferrules are inserted and thereby held in alignment to ensure optical coupling. Alternatively, the coupling mechanism may be a known connector system in which the ferrule 430 and second ferrule 440 are housed in connectors (not shown), which mate to couple the ferrules. For example, in one embedment, the connectors are hermaphroditic connectors, meaning that the connectors can couple to themselves. In another embodiment, an adapter is used to receive the connectors to facilitate optical coupling of the ferrules. Such hermaphroditic and adapter connector systems are well known. In one embodiment, the coupling between the ferrules 430, 440 is made irreversible by adhering the ferrules to the coupling mechanism 450. Such an approach may be beneficial for securing the ferrules in position, thereby improving the ruggedness of the splice. In one embodiment, the splice 300 has fiber ends 460, 461, which are not terminated and are available to be fused along the fiber 104 using traditional fusing techniques.

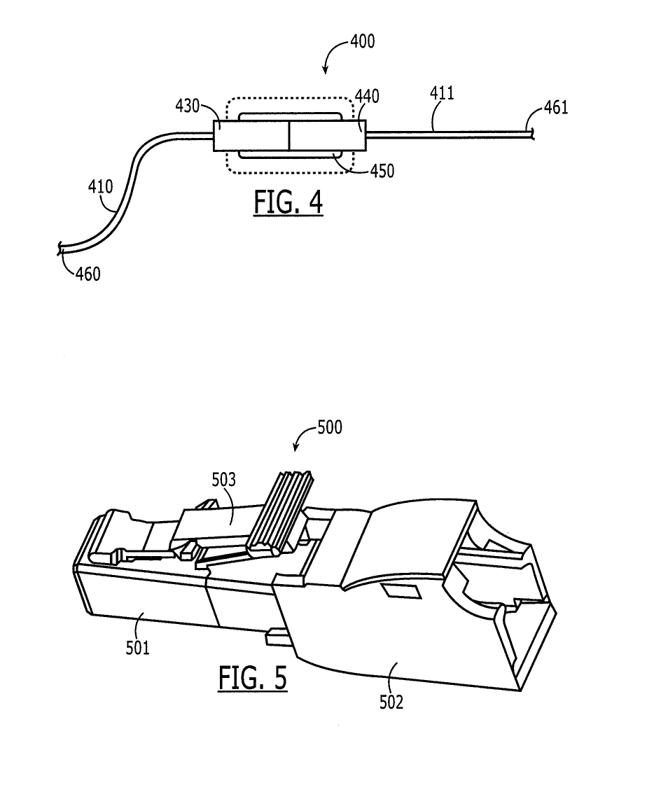

Referring to FIG. 5, yet another embodiment of the thin-film selective reflector of the present invention is shown in which the ferrule assembly 200 of FIG. 2 is incorporated into a piggyback-type connector 500. Such a connector configuration is well known and is used traditionally in “built-out” attenuator designs as shown and described in FIGS. 7a and 7b of U.S. Pat. No. 6,364,685, incorporated herein by reference. Briefly, the ferrule 200 is housed in the connector 500, which has a plug end 501 and a receptacle end 502. (The depicted connector in FIG. 5 is an LC-type connector, which also has a latch 503.) The plug end has a known geometry for interengagement with a corresponding receptacle of another connector. The receptacle end is configured to receive a plug end of another connector. The receptacle end has typically (although not necessarily) the same geometry as the plug end. Thus, the piggyback connector 500 can be “piggybacked” on another connector to dispose the thin-film selective reflector in the optical path of fiber 104.

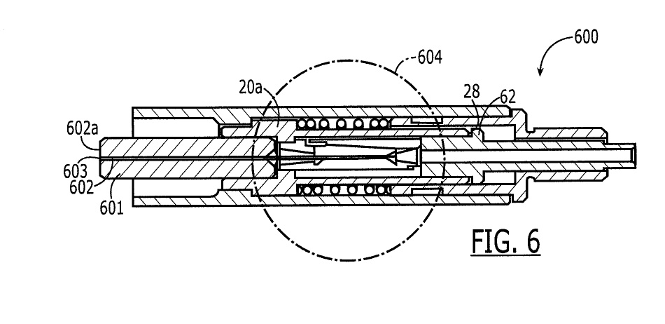

Referring to FIG. 6, yet another embodiment of the thin-film selective reflector of the present invention is shown. In this embodiment, the thin-film selective reflector comprises a field-installable connector 600. Such connectors are well known and described for example in U.S. Pat. No. 7,331,719, incorporated herein by reference. Briefly, the field-installable connector 600 comprises a ferrule 601 containing a fiber stub 602 with an end face 602a. In one embodiment, as with the ferrule 200 shown in FIG. 2, the end face 602a is coated with a thin-film selective reflector 603. Alternatively, the thin-film reflector may be disposed on the other end of the fiber stub—i.e., the end that is internal to the connector. Such an embodiment may be preferred under certain circumstances because the end face 602a is then free to be shaped to optimize the connection. For example, if the thin-film reflector is disposed on the internal face of the fiber stub, then end face 602a may be a 90° end face for standard physical contact (PC) connections or it may be angled for an angled physical contact (APC) connections. The connector 600 in this embodiment has a clamping mechanism 504 to secure a terminating fiber to the connector such that the terminating fiber and fiber stub 602 optically couple. Thus, the fiber 104 as shown in FIG. 1 may be terminated readily with the connector 600 in the field.

Still other embodiments using a thin film on the end face of a ferrule as a broadband filter will be obvious to those of skill in the art in light of this disclosure. For example, the ferrule 200 may be optically connected to the fiber 104 by splicing the fiber 203 to the end of the fiber 104. In this embodiment, the ferrule 200 may also be incorporated into a connector for easy connection to the modem or another fiber.

Therefore, the present invention can be practiced in any way in which the thin-film selective reflector 110 is optically coupled between the fiber 104 and the modem 103 approximate to the modem 103.

The ferrule of the present invention is readily prepared economically and with a high degree of repeatability. In one embodiment, the process involves terminating a fiber in a ferrule and polishing the mating face of the ferrule as is known in the art. Next, a thin film is deposited on the polished mating face of the ferrule such that it covers at least the end face of the fiber.

The filter may comprise any material known for reflecting desired wavelengths. Suitable materials include, for example, AlsO3, Al, CeF3, La2O3, MgF2, ZnS, and ZrO2. As in known in the art, the thickness of the material in the thin film affects the reflected wavelength. One of skill in the art will be able to determine the thickness of the film to achieve suitable results without undue experimentation.

The deposition of the material on the ferrule mating face can be accomplished in different ways, including, for example, vapor deposition or sputtering. In one embodiment, the vapor deposition of the material is used. This is a known process and facilitates large-scale manufacturing with a high degree of precision.

To protect the filter film, a protective coating may also be deposited over the film. Suitable protective layers include, for example, silicon oxide or any other transparent material.

In one embodiment, the ferrule in tested after the film is applied to determine whether it reflects the test wavelength, while allowing the other signal wavelengths to pass through. If it passes testing, it may be incorporated into a more elaborate thin-film selective reflector as described above.

Various steps can be used to enhance manufacturability. For example, in one embodiment, prior to the deposition of the thin film in the ferrule, the ferrule is secured to a metal base. This improves its handling and facilitates automation. Furthermore, to add efficiency to the manufacturing process, in one embodiment, a fiber segment is terminated at both ends with a ferrule. A film is then deposited on both ferrules as described above. Next, the fiber segment is separated between the two ferrules to define the ferrule 200 having a thin-film selective reflector 204 and an extending fiber 203 as shown in FIG. 2. This ferrule then can be incorporated into different embodiments of the thin-film selective reflector as described above. For example, in the patch cord 300 embodiment (see FIG. 3), the fiber 203 is terminated with a second ferrule at the other end using traditional techniques. Prior to the termination of the second ferrule, it may be preferable to slide necessary connector components onto the fiber 203. With respect to the splice 400, the thin film ferrule is coupled to a second ferrule having a fiber segment extending from it. With respect to the piggyback 400 embodiment, the fiber extension is cleaved and the opposite of the ferrule polished. It is then incorporated into the piggyback connector using known techniques. With respect to the field-installable connector 600, the end of fiber 203 may be cleaved and then disposed in the clamping assembly as described in U.S. Pat. No. 7,331,719. Alternatively, the ferrule 200 may be prepared with just a fiber stub such that it terminates within the ferrule. Still other preparation approaches will be known to one of skill in the art in light of this disclosure.

While the present invention has been particularly shown and described with reference to the preferred mode as illustrated in the drawing, it will be understood by one skilled in the art that various changes in detail may be effected therein without departing from the spirit and scope of the invention as defined by the claims.

What is claimed is:

1. A system for testing an optical network, said system comprising:
a fiber having first and second ends;
a transmitter connected to said first end of said fiber and configured to launch a test signal having a first wavelength down said fiber; and
a thin-film selective reflector configured to reflect said first wavelength, said thin-film selective reflector optically connected to said second end of said first fiber.

2. The system of claim 1, wherein said thin-film selective reflector comprises a ferrule having a mating face and holding a second fiber having an end face, and a layer of thin film reflective material disposed at least on said end face.

3. The system of claim 2, wherein said end face of said second fiber is presented at said mating face.

4. The system of claim 2, wherein said end face is at one end of said second fiber and the other end of said second fiber is presented at said mating face.

5. The system of claim 4, wherein said thin-film selective reflector comprises a field-installable connector and said second fiber is a fiber stub in said field installable connector.

6. The system of claim 2, further comprising:
a server at said first end for transmitting optical signals down said first fiber;
a modem at said second end for converting said signals to electrical signals; and
wherein said thin-film selective reflector is optically connected between said second end and said modem.

7. The system of claim 6, wherein said second fiber extends from said ferrule to a second end, said second end being terminated with a second ferrule, said ferrule and said second ferrule being contained in first and second connectors, respectively, and wherein said second end of said fiber is terminated with a third connector, said first and third connectors being optically connected, said second connector being operatively connected to said modem.

8. The system of claim 6, wherein said second fiber extends from said ferrule to a second end, said second end being fused to said fiber and further comprising a second ferrule containing a first end of a third fiber, said third fiber being optically connected to said modem, and a coupling mechanism to optically couple said ferrule and said second ferrule.

9. A thin-film selective reflector comprising:
a ferrule having a mating face;
a fiber having a first end disposed in said ferrule and having an end face; and
a thin layer of reflective material disposed on at least said end face.

10. The thin-film selective reflector of claim 9, wherein said end face is presented at said mating face.

11. The thin-film selective reflector of claim 9, wherein said fiber extends from said ferrule to a second end

12. The thin-film selective reflector of claim 11, further comprising:
a first connector containing said ferrule; and
a second connector terminated to said second end of said fiber.

13. The thin-film selective reflector of claim 11, further comprising:
a second ferrule containing a first end of a second fiber
a coupling mechanism to optically couple said ferrule and said second ferrule.

14. The thin-film selective reflector of claim 13, wherein said coupling mechanism is a sleeve.

15. The thin-film selective reflector of claim 10, wherein said ferrule comprises a second face and a second end face of said fiber is presented at said second face, and further comprising:
a piggyback connector containing said ferrule.

16. The thin-film selective reflector of claim 15, wherein said piggyback connector has first and second ends, said first end configured to be received in a receptacle of a certain geometry, and said second end having a receptacle of said certain geometry.

17. The thin-film selective reflector of claim 9, wherein said fiber is a fiber stub and further comprising:
a field-installable connector containing said ferrule and having a clamping mechanism to optically couple a terminating fiber to said fiber stub.

18. The thin-film selective reflector of claim 17, wherein said end face is at one end of said fiber stub and the other end of said fiber stub is presented at said mating face.

19. The thin-film selective reflector of claim 18, wherein said fiber stub extends from said ferrule.

20. The thin-film selective reflector of claim 18, wherein said fiber stub terminates inside said ferrule.

21. A method of preparing a thin-film selective reflector, said method comprising:
terminating a fiber with at least one ferrule and polishing a mating face of said ferrule to present an end face of said fiber; and
disposing a thin film of reflective material on at least said end face of the fiber to reflect a certain wavelength.

22. The method of claim 21, wherein each end of said fiber is terminated with a ferrule and a thin film of reflective material is disposed on each end face of each fiber contained in the ferrules.

23. The method of claim 22, further comprising:
separating said fiber between said two ferrules to define two thin-film selective reflector ferrules with an extending fiber.

24. The method of claim 23, further comprising terminating said extending fiber with a second ferrule.

25. The method of claim 24, wherein terminating comprises splicing with a second fiber terminated with a ferrule.
